(19) United States
(12) Patent Application Publication
(10) Pub. No.: US 2010/0121544 A1
(43) Pub. Date: May 13, 2010

(54) DRIVING POWER DISTRIBUTION CONTROL APPARATUS, DIFFERENTIAL LIMITING CONTROL APPARATUS, METHOD FOR CONTROLLING TORQUE COUPLING, AND METHOD FOR CONTROLLING DIFFERENTIAL APPARATUS

(75) Inventors: Akira Kodama, Chiryu-shi (JP); Ryohei Shigeta, Anjo-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: JTEKT CORPORATION, Osaka-shi (JP)

(21) Appl. No.: 12/614,744

(22) Filed: Nov. 9, 2009

(30) Foreign Application Priority Data
Nov. 7, 2008 (JP) 2008-286841

(51) Int. Cl. G06F 19/00

(52) U.S. Cl. 701/58

(57) ABSTRACT

A driving power distribution control apparatus includes a torque coupling and an ECU. The torque coupling is provided in a drive power transmission system that transmits torque of an engine to each of a plurality of wheels. Based on the frictional engaging force of an electromagnetic clutch, the torque coupling is capable of changing the amount of torque that can be transmitted to right and left rear wheels, which serve as auxiliary drive wheels. The ECU controls the operation of the torque coupling based on the driving state of the vehicle. When slip of any one of the wheels is detected, the ECU reduces the torque transmission amount to a predetermined torque or a lower value.

### BACKGROUND OF THE INVENTION

The present invention relates to a driving power distribution control apparatus, a differential limiting control apparatus, a method for controlling a torque coupling, and a method for controlling a differential apparatus.

Conventionally, driving power distribution control apparatuses have been known that are located in a driving power transmission system for transmitting the torque of an engine to wheels and have a torque coupling. Based on the engaging force of a clutch mechanism, the torque coupling changes transmittable torque amount, that is, torque transmission amount, from an input side to an output side. For example, Japanese Laid-Open Patent Publication No. 2005-3167 discloses a torque coupling that includes a cylindrical first rotating member and a shaft-like second rotating member. The second rotating member is rotatably and coaxially arranged relative to the first rotating member. The torque coupling includes a clutch mechanism, which is located between the first rotating member and the second rotating member. The clutch mechanism couples the first rotating member and the second rotating member to each other so that torque can be transmitted therebetween.

When a four-wheel drive vehicle equipped with a driving power distribution control apparatus is running on a road surface that is partially frozen and thus includes high μ road surface and low μ road surface, the vehicle may skid if one of the wheels enters the low μ road surface. When the slipping wheel exits the low μ road surface and enters the high μ road surface, the wheel starts holding the road surface, which abruptly increases the reaction from the road surface. The speed of the wheel thus abruptly drops. This can apply a shock to the driving power transmission system (for example, the propeller shaft).

Accordingly, the driving power distribution control apparatus disclosed in, for example, Japanese Laid-Open Patent Publication No. 2003-320857 reduces the torque transmission amount of the torque coupling when the deceleration of a wheel is greater than or equal to a predetermined value. This prevents torque that is greater than or equal to the torque transmission amount from being transmitted to a portion of the transmission system that is located beyond the torque coupling as seen from a slipping wheel.

Typically, when a vehicle is moving without skidding, each wheel is holding the road surface. In this case, torsion is generated in the driving power transmitting members forming the driving power transmission system. Thus, when a four-wheel drive vehicle is running on a road surface having high μ road surface and low μ road surface, the torsion of the driving power transmitting members is released if a wheel slips on the low μ road surface, which produces torsional vibration. However, according to the configuration of the above described prior art structure, since the torque transmission amount is reduced by detecting deceleration of the wheels, the torsional vibration generated during slipping cannot be prevented.

This problem is not limited to a case where a torque coupling is provided in a driving power transmission system, but also occurs in a four-wheel drive vehicle having a differential apparatus that has a limited slip differential. The differential apparatus distributes torque to vehicle wheels while permitting the left wheels and the right wheels to rotate at different speeds or permitting the front wheels and the rear wheels to rotate at different speeds, and the limited slip differential limits the speed difference between the left wheels and the right wheels and between the front wheels and the rear wheels.

### SUMMARY OF THE INVENTION

Accordingly, it is an objective of the present invention to provide a driving power distribution control apparatus, a differential limiting control apparatus, a method for controlling a torque coupling, and a method for controlling a differential apparatus that reduce shock applied to a driving power transmission system due to slipping of wheels.

To achieve the foregoing objective and in accordance with a first aspect of the present invention, a driving power distribution control apparatus for controlling driving power that is distributed from a driving power source of a vehicle to each of a plurality of wheels is provided. The apparatus includes a torque coupling, a torque transmission amount controller, and slip detection means. The torque coupling is provided in a driving power transmission system that transmits, as the driving power, torque of the driving power source to each of the wheels. Based on an engaging force of a clutch mechanism that transmits the driving power, the torque coupling is capable of changing the amount of torque transmission, which amount is torque that is transmittable from an input side to an output side. The torque transmission amount controller controls the operation of the torque coupling based on the driving state of the vehicle. The slip detection means detects slip of wheels. When the slip detection means detects that at least one of the wheels has slipped, the torque transmission amount controller reduces the torque transmission amount of the torque coupling.

In accordance with a second aspect of the present invention, a differential limiting control apparatus including a differential apparatus, a differential limiting force controller, and slip detection means is provided. The differential apparatus transmits torque of a driving power source of a vehicle to a first drive shaft and a second drive shaft, while permitting the first and second drive shafts to rotate at different speeds. The differential apparatus has a limited slip differential that limits the speed difference between the first drive shaft and the second drive shaft. The differential limiting force controller controls a differential limiting force of the limited slip differential. The slip detection means detects slip of any of wheels that are coupled to the first drive shaft or the second drive shaft. When the detection means detects slip of a wheel coupled to the first drive shaft or the second drive shaft, the differential limiting force controller reduces the differential limiting force of the limited slip differential.

In accordance with a third aspect of the present invention, a method for controlling a torque coupling provided in a driving power transmission system that transmits, as a driving power, torque of a driving power source to each of a plurality of wheels, is provided. Based on an engaging force of a clutch mechanism that transmits the driving power, the torque coupling is capable of changing the amount of torque transmission, which amount is torque that is transmittable from an input side to an output side. When it is detected that at least one of the wheels has slipped, the torque transmission amount of the torque coupling is reduced.

In accordance with a fourth aspect of the present invention, a method for controlling a differential apparatus that transmits torque of a driving power source of a vehicle to a first drive shaft and a second drive shaft, while permitting the first and second drive shafts to rotate at different speeds, is provided. The differential apparatus has a limited slip differential that limits the speed difference between the first drive shaft and the second drive shaft. When it is detected that at least one of the wheels has slipped, the differential limiting force of the limited slip differential is reduced.

### BRIEF DESCRIPTION OF THE DRAWINGS

FIG. 1 is a diagram showing a four-wheel drive vehicle equipped with a driving power distribution control apparatus according to a first embodiment of the present invention;

FIG. 2 is a block diagram showing an ECU;

FIG. 3 is a flowchart showing a switching process of the control mode of the ECU;

FIG. 4 is a flowchart showing a process of switching determination from normal control to protection control;

FIG. 5 is a flowchart showing a process of return determination from the protection control to the normal control;

FIGS. 6A to 6C are diagrams showing a condition in which a four-wheel drive vehicle runs on a road partially having a low μ road surface;

FIG. 7 is a diagram showing a four-wheel drive vehicle equipped with a differential limiting control apparatus according to a second embodiment of the present invention; and

FIG. 8 is a diagram showing a four-wheel drive vehicle equipped with a differential limiting control apparatus according to a third embodiment of the present invention.

### DETAILED DESCRIPTION OF THE PREFERRED EMBODIMENTS

### First Embodiment

A first embodiment of the present invention will now be described with reference to the drawings.

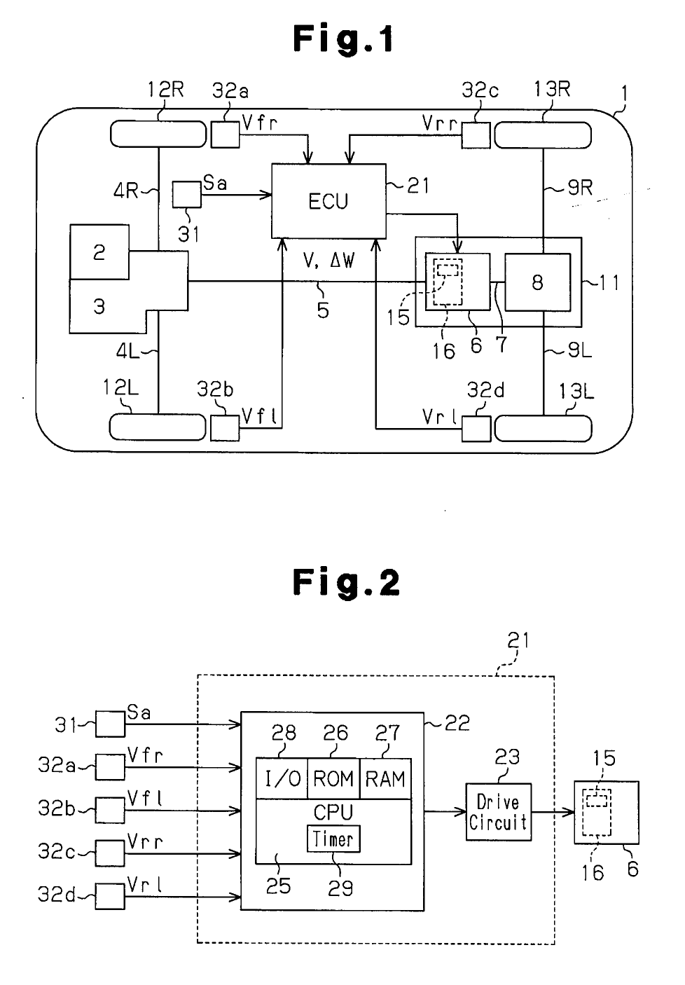

As shown in FIG. 1, a vehicle 1 is a front drive-based four-wheel drive vehicle. An engine 2 serving as a driving power source is mounted in a front portion (a left portion as viewed in FIG. 1) of the vehicle 1. A transaxle 3 is attached to the engine 2. The transaxle 3 includes a transmission, a transfer case, and a front differential. A pair of right and left front axles 4R, 4L are coupled to the transaxle 3. A propeller shaft 5 is coupled to the transaxle 3. The propeller shaft 5 can be coupled to a pinion shaft (drive pinion shaft) 7 with a torque coupling 6. The pinion shaft 7 is coupled to a pair of right and left rear axles 9R, 9L with a rear differential 8 in between. The rear differential 8 is configured to permit the left rear axle 9L and the right rear axle 9R to rotate at different speeds and to distribute the torque of the engine 2 transmitted through the pinion shaft 7 to the right and left rear axles 9R, 9L in accordance with the speed difference of the rear axles 9L, 9R. A differential carrier 11 is fixed to a frame (not shown) of the vehicle 1. The torque coupling 6, together with the rear differential 8, is accommodated in the differential carrier 11.

That is, the torque of the engine 2 is constantly transmitted to the right and left front wheels 12R, 12L via the transaxle 3 and the right and left front axles 4R, 4L. When the propeller shaft 5 and the pinion shaft 7 are coupled to each other by the torque coupling 6 so that torque can be transmitted therebetween, the torque of the engine 2 is transmitted to right and left rear wheels 13R, 13L through the propeller shaft 5, the pinion shaft 7, the rear differential 8, and the right and left rear axles 9R, 9L.

Therefore, in the first embodiment, the right and left front wheels 12R, 12L function as main drive wheels, to which the torque of the engine 2 is always transmitted, and the right and left rear wheels 13R, 13L function as auxiliary drive wheels, to which the torque of the engine 2 is transmitted as necessary. Driving power transmitting members, which include the transaxle 3, the right and left front axles 4R, 4L, the propeller shaft 5, the torque coupling 6, the pinion shaft 7, the rear differential 8, the right and left rear axles 9R, 9L, form a driving power transmission system that transmits the torque of the engine 2 to the wheels 12R, 12L, 13R, 13L.

The torque coupling 6 includes an electromagnetic clutch 16, which serves as a clutch mechanism. The electromagnetic clutch 16 includes an electromagnetic coil 15 and a plurality of clutch plates located in the vicinity of the propeller shaft 5 and the pinion shaft 7. In accordance with the amount of current supplied to the electromagnetic coil 15, the frictional engaging force the clutch plates is changed. Based on the frictional engaging force of the electromagnetic clutch 16, the torque coupling 6 inputs torque from the propeller shaft 5 on the input side and outputs the torque to the pinion shaft 7 on the output side away from the engine 2. That is, the torque coupling 6 (the electromagnetic clutch 16) adjusts the torque that can be transmitted to the right and left rear wheels 13R, 13L, which serve as auxiliary drive wheels. In other words, the torque coupling 6 adjusts the torque transmission amount.

The electrical configuration of the vehicle 1, which is constructed as described above, will now be described.

The torque coupling 6 is connected to an ECU (electronic control unit) 21, which functions as a torque transmission amount controller and slip detection means. As shown in FIG. 2, the ECU 21 includes a microcomputer 22 and a drive circuit 23.

The microcomputer 22 includes a CPU 25, which performs various computations, a ROM 26, which stores control programs, a RAM 27, which functions as a working area of the CPU 25, and an input-output circuit (I/O) 28, which inputs and outputs signals from and to various types of sensors and the drive circuit 23. The CPU 25, the ROM 26, the RAM 27, and the input-output circuit (I/O) circuit 28 exchange data with each other through a bidirectional bus. The CPU 25 also includes a timer 29. The timer 29 measures time based on a command from the CPU 25.

Through operations of the microcomputer 22 and the drive circuit 23, the ECU 21 supplies drive current to the electromagnetic coil 15 of the electromagnetic clutch 16 in accordance with the driving state of the vehicle 1. Through the supply of current, the ECU 21 controls the operation of the torque coupling 6, thereby changing the torque transmission amount. That is, the torque coupling 6 and the ECU 21 form a driving power distribution control apparatus.

Specifically, as shown in FIGS. 1 and 2, the ECU 21 is connected to an accelerator pedal position sensor 31 and a vehicle wheel speed sensors 32a to 32d. Based on the right front wheel speed Vfr and the left front wheel speed VFl, and the right rear wheel speed Vrr and the left rear wheel speed Vrl detected by the wheel speed sensors 32a to 32d, the ECU 21 computes the vehicle speed V and a front-rear wheel speed difference AW between the front wheels 12R, 12L and the rear wheels 13R, 13L. In the first embodiment, the ECU 21 sets, as a vehicle speed V, the average value of the right rear wheel speed Vrr and the left rear wheel speed Vrl, and sets, as front-rear wheel speed difference ΔW, the difference between the average value of the right front wheel speed Vfr and the left front wheel speed Vfl and the average value of the right rear wheel speed Vrr and the left rear wheel speed Vrl. The ECU 21 computes a control target value (target torque τp) based on the vehicle speed V, the front-rear wheel speed difference ΔW, and the accelerator pedal depression degree Sa.

Specifically, by referring to a torque map stored in the ROM 26, the ECU 21 computes a first torque based on the vehicle speed V and the accelerator pedal depression degree Sa, and a second torque based on the vehicle speed V and the front-rear wheel speed difference ΔW. Next, the ECU 21 adds up the first torque and the second torque to compute the target torque τp, which corresponds to the current vehicle speed V, the accelerator pedal depression degree Sa, and the front-rear wheel speed difference ΔW. The torque map is configured such that the lower the vehicle speed V and the greater the accelerator pedal depression degree Sa, the greater the first torque becomes, and that the lower the vehicle speed V and the greater the front-rear wheel speed difference ΔW, the greater the second torque becomes.

The ECU 21 the supplies an electric current to the electromagnetic clutch 16 so as to generate a frictional engaging force that corresponds to the determined target torque τp. Accordingly, the ECU 21 controls the operation of the torque coupling 6, or the distribution of the drive force between the right and left front wheels 12R, 12L and the right and left rear wheels 13R, 13L.

The ECU 21 executes protection control for reducing a shock applied to the driving power transmission system when one of the wheels slips.

The ECU 21 executes the protection control when only one of the wheels 12R, 12L, 13R, 13L slips, so as to reduce the target torque τp to a predetermined torque τth or lower. The predetermined torque τth is a value at which it is possible to prevent torsional vibration generated when torsion of a specific driving power transmitting member (for example, the left front axle 4L) is released from being transmitted to the other driving power transmitting members. For example, the predetermined torque τth is set to zero.

In contrast to the protection control, control mode in which the target torque τp is determined based on the driving state of the vehicle 1 (the vehicle speed V, the front-rear wheel speed difference ΔW, and the accelerator pedal depression degree Sa) is referred to as normal control.

The normal control and the protection control will now be described. The ECU 21 computes differences between the wheel speed of one of the wheels 12R, 12L, 13R, 13L (for example, the right front wheel 12R) and the speeds of the other wheels (the wheels 12L, 13R, 13L). Then, the ECU 21 performs the same computation for all the wheels 12R, 12L, 13R, 13L, and determines whether the vehicle is skidding based on the wheel speed differences between the wheels 12R, 12L, 13R, 13L (between the four wheels).

In the normal control, the ECU 21 determines whether slip is taking place by taking into consideration whether the wheel speed of any one of the wheels is greater than or equal to a value calculated by adding a first threshold amount K1 to an average wheel speed of the other three wheels, and whether all the wheel speed differences between the latter three wheels are less than or equal to a second threshold value K2. When the wheel speed of one of the wheels is greater than or equal to the value calculated by adding the first threshold amount K1 to the average wheel speed of the other three wheels, and all the wheel speed differences between the latter three wheels are less than or equal to the second threshold value K2, the ECU 21 determines that only the first wheel has slipped and switches the control mode from the normal control to the protective mode.

In the protection control, the ECU 21 determines whether the slipping of only the one wheel has continued for a predetermined period (for example, 200 msec). That is, the ECU 21 determines whether a state has continued for a predetermined period Tth in which state the wheel speed of one of the wheels is greater than or equal to the value calculated by adding the first threshold amount K1 to the average wheel speed of the other three wheels, and all the wheel speed differences between the latter three wheels are less than or equal to the second threshold value K2. If slipping of only one of the wheels has continued for the predetermined period Tth, the ECU 21 determines that torsional vibration has been damped and the shock applied to the driving power transmission system has been decreased. In this case, the ECU 21 switches the control mode from the protection control to the normal control.

During the protection control, the ECU 21 determines whether the wheel speed differences between the four wheels are all less than or equal to the second threshold value K2. When the wheel speed differences between the four wheels are all less than or equal to the second threshold value K2, the ECU 21 determines that slipping of any of the wheels has stopped, and switches the control mode from the protection control to the normal control.

Further, in the protection control, the ECU 21 determines whether the accelerator pedal depression degree Sa is less than or equal to a predetermined depression degree Sath. The predetermined depression degree Sath corresponds to the depression degree when the driver is substantially not depressing the accelerator pedal (not shown). When the accelerator pedal depression degree Sa is less than or equal to the predetermined depression degree Sath, the ECU 21 determines that slipping of any of the wheels has stopped because the output from the engine 2 is substantially stopped, and switches the control mode from the protection control to the normal control.

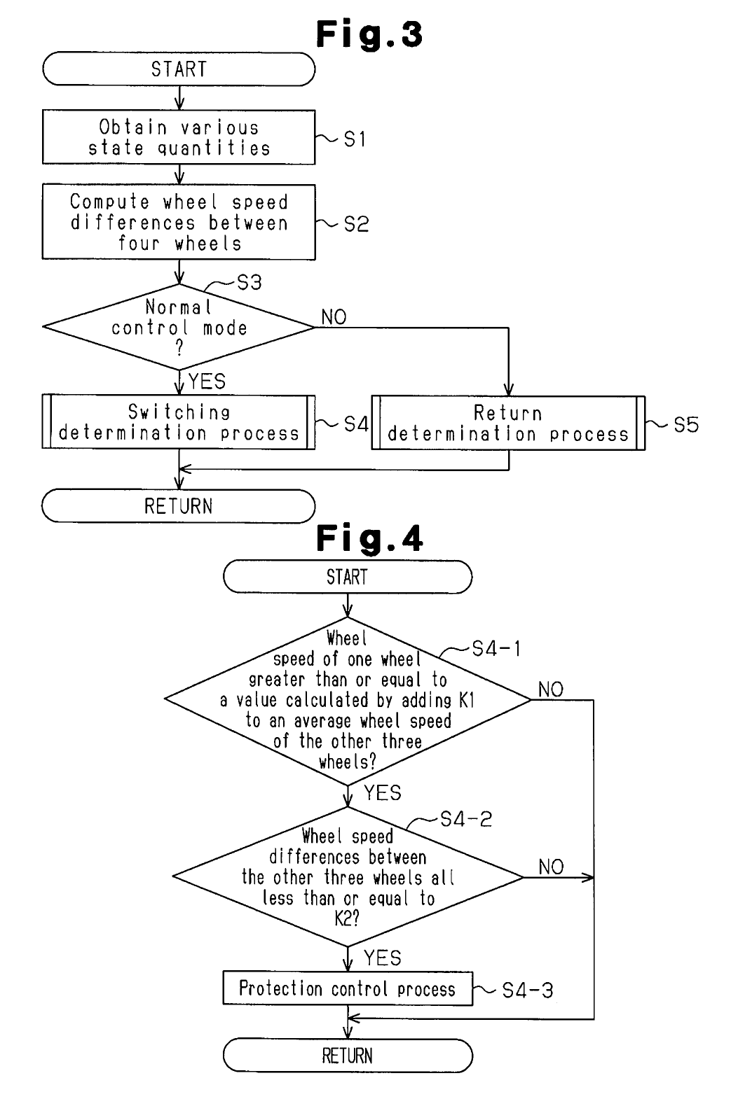

Next, an operation of the driving power distribution control apparatus according to the first embodiment will be described with reference to the flowcharts of FIGS. 3 to 5, which represent a procedure executed by ECU 21.

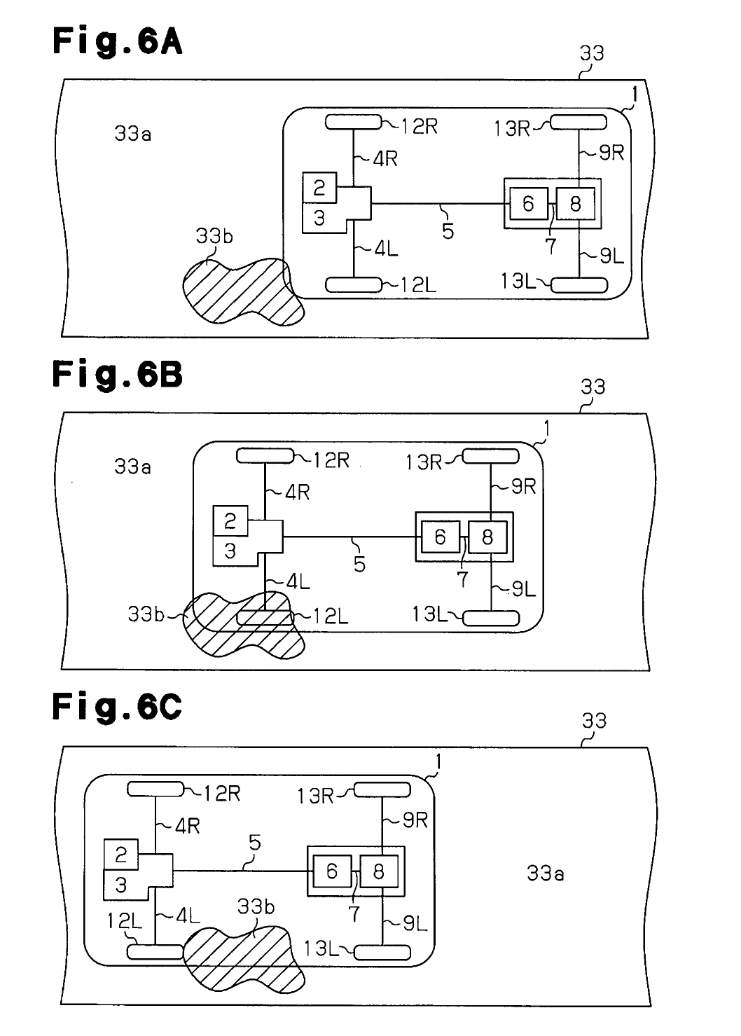

While the vehicle 1 is running on a road 33 as shown in FIGS. 6A to 6C, the ECU 21 repeats the procedure of steps S1 to S5 shown in the flowchart of FIG. 3 at a predetermined cycle. To facilitate illustration, a low μ road surface 33b is illustrated with hatching so as to be distinguished from a high μ road surface 33a in FIGS. 6A to 6C.

First, at step S1, the ECU 21 obtains various state quantities (the accelerator pedal depression degree Sa, the wheel speeds Vfr, Vfl, Vrr, Vrl) from the accelerator pedal position sensor 31 and the wheel speed sensors 32a to 32d. Subsequently, based on the accelerator pedal depression degree Sa and the wheel speeds Vfr, Vfl, Vrr, Vrl, the ECU 21 computes the wheel speed differences between the four wheels (step S2).

After obtaining the wheel speed differences between the four wheels, the ECU 21 determines whether the current control mode is the normal control (step S3). If the current control mode is the normal control mode (YES at step S3), the ECU 21 executes a switching determination process for determining whether to switch the control mode from the normal control mode to the protection control mode (step S4).

In the switching determination process, the ECU 21 determines whether the wheel speed of any one of the four wheels is greater than or equal to the value calculated by adding the first threshold amount K1 to the average wheel speed of the other three wheels as shown in FIG. 4 (step S4-1). That is, based on the computation results obtained at step S2, the ECU 21 determines whether the wheel speed of the slipping one of the four wheels is greater than or equal to the value calculated by adding the first threshold amount K1 to the average wheel speed of the other three wheels, which are not slipping.

When the vehicle 1 is running on the high μ road surface 33a of the road 33 as shown in FIG. 6A, the ECU 21 determines that the wheels 12R, 12L, 13R, 13L are not slipping and none of the wheels 12R, 12L, 13R, 13L is rotating at a wheel speed greater than or equal to the value calculated by adding the first threshold amount K1 to the average wheel speed of the other three wheels (NO at step S4-1). The ECU 21 returns to step S1 while maintaining the control mode at the normal control mode. At this time, since the wheels 12R, 12L, 13R, 13L hold the high μ road surface 33a, torsion is occurring in the driving power transmitting members such as the left front axle 4L.

In contrast, when the vehicle 1 advances and the left front wheels 12L enters the low μ road surface 33b, the left front wheel 12L slips. Thus, the wheel speed of the left front wheel 12L becomes greater than or equal to the value calculated by adding the first threshold amount K1 to the average wheel speed of the other three wheels (the wheels 12R, 13R, 13L) (YES at step S4-1). Thus, the ECU 21 determines whether the wheel speed differences between the other three wheels are all less than or equal to the second threshold value K2 (step S4-2).

At this time, since the other three wheels (the wheels 12R, 13R, 13L) are holding the high μ road surface 33a in the state shown in FIG. 6B, the wheel speed differences between the three wheels are all less than or equal to the second threshold value K2. Accordingly, the ECU 21 determines that only the left front wheel 12L is slipping.

When determining that only the left front wheel 12L is slipping (YES at step S4-2), the ECU 21 switches the control mode from the normal control mode to the protection control mode (step S4-3). After switching to the protection control mode, the ECU 21 returns to step S1. If, for example, two of the four wheels are slipping (NO at step S4-2), the ECU 21 returns to step S1 while maintaining the control mode at the normal control mode.

After switching to the protection control mode, the ECU 21 continues the protection control until the control mode is switched to the normal control mode.

That is, the ECU 21 reduces the target torque τp to value less than or equal to the predetermined torque τth, thereby preventing the torsional vibration produced by the release of torsion of the left front axle 4L from being transmitted to a portion of the driving power transmission system that is located beyond the torque coupling 6 as seen from the left front wheel 12L, that is, to the pinion shaft 7, the rear differential 8, and the right and left rear axles 9R, 9L.

When the protection control mode is started, the ECU 21 determines that the control mode has been switched from the normal control mode to the protection control mode at step S3 (NO at step S3). Then, the ECU 21 executes a return determination process for determining whether to return the control mode from the protection control mode to the normal control mode (step S5).

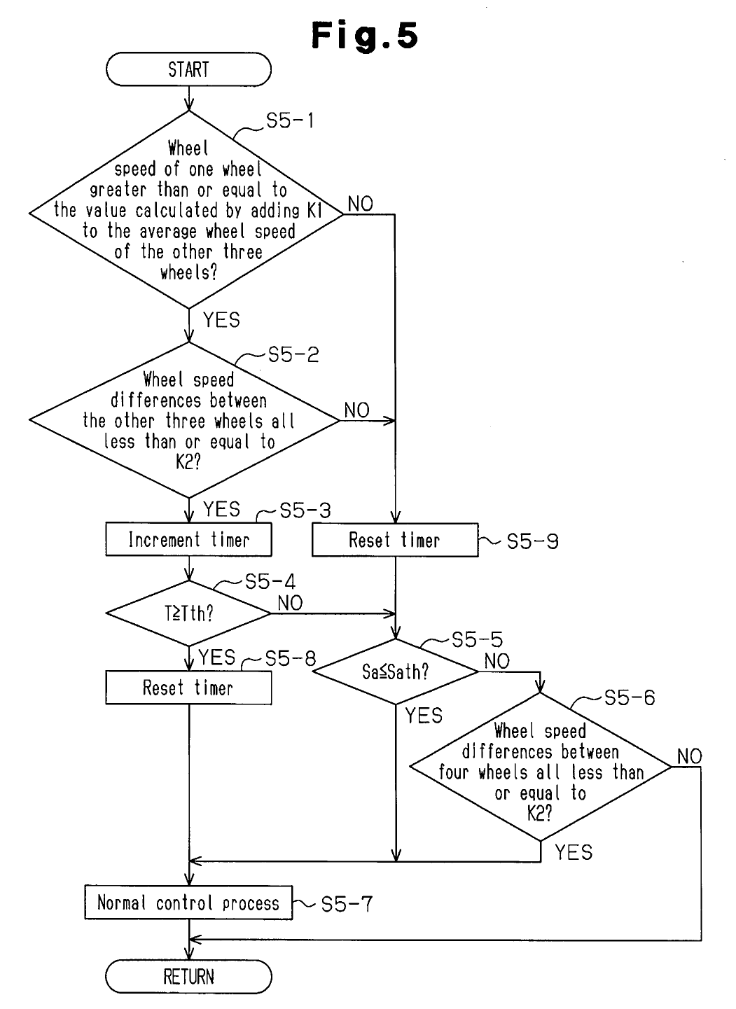

In the return determination process, the ECU 21 determines whether the wheel speed of any one of the four wheels (in this case, the left front wheel 12L) is greater than or equal to the value calculated by adding the first threshold amount K1 to the average wheel speed of the other three wheels as shown in FIG. 5 (step S5-1). That is, based on the computation results obtained at step S2, the ECU 21 determines whether the wheel speed of the slipping left front wheel 12L is greater than or equal to the value calculated by adding the first threshold amount K1 to the average wheel speed of the other three wheels, which are not slipping.

In the state shown in FIG. 6B, the left front wheel 12L continues slipping, and the wheel speed of the left front wheel 12L is greater than or equal to the value calculated by adding the first threshold amount K1 to the average wheel speed of the other three wheels (the wheels 12R, 13R, 13L) (YES at step S5-1). Thus, the ECU 21 determines whether the wheel speed differences between the other three wheels are all less than or equal to the second threshold value K2 (step S5-2).

At this time, the other three wheels (the wheels 12R, 13R, 13L) are holding the high μ road surface 33a. Thus, the wheel speed differences between the three wheels are all less than or equal to the second threshold value K2. Accordingly, the ECU 21 determines that only the left front wheel 12L is slipping (YES at step S5-2) and proceeds to step S5-3.

At step S5-3, the ECU 21 increments a count value T of the incorporated timer 29 by one. Thereafter, the ECU 21 determines whether the count value T has become greater than or equal to a predetermined value (the predetermined period Tth). The predetermined period Tth is a period required for torsional vibration to be damped after the left front wheel 12L starts slipping and for shock applied to the driving power transmission system to become small. At this point, since the left front wheel 12L has just started slipping, the ECU 21 determines that the predetermined period Tth has not elapsed.

When determining that the left front wheel 12L has not continued slipping for the predetermined period Tth (NO at step S5-4), the ECU 21 determines whether the accelerator pedal depression degree Sa is less than or equal to the predetermined depression degree Sath (step S5-5). Specifically, the ECU 21 determines whether the driver has released the accelerator pedal to substantially stop the driving power output from the engine 2, thereby decreasing the slipping of the left front wheel 12L.

At this time, since the left front wheel 12L has just started slipping, and the elapsed time is less than or equal to the predetermined period Tth, the driver is still stepping on the accelerator pedal. Therefore, at this point, the ECU 21 determines that the driver has not released the accelerator pedal and the accelerator pedal depression degree Sa has not become less than or equal to the predetermine depression degree Sath. In this case, the ECU 21 proceeds to step S5-6.

At step S5-6, the ECU 21 determines whether the wheel speed differences between the four wheels are all less than or equal to the second threshold value K2. Here, the ECU 21 determines whether the left front wheel 12L has exited the low μ road surface 33b. That is, after the left front wheel 12L exits the low μ road surface 33b, since the wheels 12R, 12L, 13R, 13L hold the high μ road surface 33a, the wheel speed differences between the four wheels are all less than or equal to the second threshold value K2. That is, by determining whether the wheel speed differences between the four wheels are all less than or equal to the second threshold value K2, the ECU 21 determines whether the left front wheel 12L has exited the low μ road surface 33b.

At this point, since the left front wheel 12L has not exited the low μ road surface 33b, the ECU 21 determines that the wheel speed differences of the four wheels are all less than or equal to the second threshold value K2 (NO at step 5-6). Then, the ECU 21 returns to step S1 and repeats the protection control mode.

When the vehicle 1 advances further, the left front wheel 12L exits the low μ road surface 33b. Then, when determining that the wheel speed differences between the four wheels are all less than or equal to the second threshold value K2 (YES at step 5-6). At step S5-6, the ECU 21 switches the control mode from the protective mode to the normal control mode (step S5-7). After switching to the normal control mode, the ECU 21 returns to step S1 and continues the normal control until the control mode is switched to the protection control mode.

If the ECU 21 determines that the accelerator pedal depression degree Sa has become less than or equal to the predetermined depression degree Sath (YES at step S5-5), that is, if the ECU 21 determines that the driving power output from the engine 2 is substantially stopped and that the slipping of the left front wheel 12L has subsided, the ECU 21 moves to step S5-7 and switches the control mode from the protective mode to the normal mode.

Further, if the ECU 21 determines that the left front wheel 12L has been slipping for the predetermined period Tth at step S5-4 (YES at step S5-4), the ECU 21 resets the count value T of the timer 29 and switches the control mode from the protective mode to the normal control mode (step S5-7).

Further, when the wheel speed of the left front wheel 12L is less than the value calculated by adding the first threshold amount K1 to the average wheel speed of the other three wheels (NO at step S5-1), or when the wheel speed differences between the other three wheels are all not less than or equal to the second threshold value K2 at step S5-2 (NO at step S5-2), the ECU 21 determines that the slipping of only the left front wheel 12L has subsided. At this time, the ECU 21 resets the count value T of the timer 29 (step S5-9) and proceeds to step S5-5.

As described above, the first embodiment has the following advantages.

(1) The driving power distribution control apparatus of the present invention includes the torque coupling 6 and the ECU 21. The torque coupling 6 is provided in the driving power transmission system for transmitting the torque of the engine 2 of the vehicle 1 to each of the wheels 12R, 12L, 13R, 13L. Based on the frictional engaging force of the electromagnetic clutch 16, the torque coupling 6 is capable of changing the amount of torque that can be transmitted to the right and left rear wheels 13R, 13L, which serve as auxiliary drive wheels. The ECU 21 controls the operation of the torque coupling 6 based on the driving state of the vehicle. The ECU 21 reduces the torque transmission amount of the torque coupling 6 to a value less than or equal to the predetermined torque τth when only one of the wheels 12R, 12L, 13R, 13L is slipping. When any one of the four wheels (the left front wheel 12L) slips, the torsion in a driving power transmitting member (the left front axle 4L) is released. This generates torsional vibration. The configuration of the first embodiment prevents the torsional vibration from being transmitted to a portion of the driving power transmission system that is located beyond the torque coupling 6 as seen from the slipping left front wheel 12L.

(2) When the wheel speed of any one of the wheels 12R, 12L, 13R, 13L is greater than or equal to the value calculated by adding the first threshold amount K1 to the average wheel speed of the other three wheels, and all the wheel speed differences between the latter three wheels are less than or equal to the second threshold value K2, the ECU 21 determines that only one of the four wheels has slipped. Thus, for example, when the wheel speed of the left front wheel 12L is greater than or equal to the value calculated by adding the first threshold amount K1 to the average wheel speed of the other three wheels (the wheels 12R, 13R, 13L), and the wheel speed of the right front wheel 12R is greater than or equal to the value calculated by adding the first threshold amount K1 to the average wheel speed of the other two wheels (the wheels 13R, 13L), in other words, when two wheels are slipping, the ECU 21 does not detects that only one of the wheels is slipping. Thus, slipping of only one wheel is reliably detected.

(3) When only one wheel slips for a predetermined period, the ECU 21 switches the control mode to the normal control. That is, when only one wheel slips for a predetermined period and torsional vibration is damped, the ECU 21 switches the control mode to the normal control. Accordingly, sufficient torque is distributed to the right and left rear wheels 13R, 13L in accordance with the driving state of the vehicle, which improves the traction performance.

(4) The ECU 21 switches the control mode to the normal control when determining that the wheel speed differences between the four wheels are all less than or equal to the second threshold value K2. That is, when a slipping wheel exits the low μ road surface 33b and holds the road 33 (the high μ road surface 33a) so that the slipping has subsided, the ECU 21 switches the control mode to the normal control. Accordingly, sufficient torque is distributed to the right and left rear wheels 13R, 13L in accordance with the driving state of the vehicle, which improves the traction performance.

(5) When the accelerator pedal depression degree Sa is less than or equal to the predetermined depression degree Sath, the ECU 21 switches the control mode to the normal control. That is, when the accelerator pedal depression degree Sa is less than or equal to the predetermined depression degree Sath, and slipping of a wheel has subsided because the driving power output from the engine 2 is substantially stopped, the ECU 21 switches the control mode to the normal control. Accordingly, sufficient torque is distributed to the right and left rear wheels 13R, 13L in accordance with the driving state of the vehicle, which improves the traction performance.

### Second Embodiment

A second embodiment of the present invention will now be described with reference to the drawings.

For purposes of illustration, like or same reference numerals are given to those components that are like or the same as the corresponding components of the first embodiment and detailed explanations are omitted.

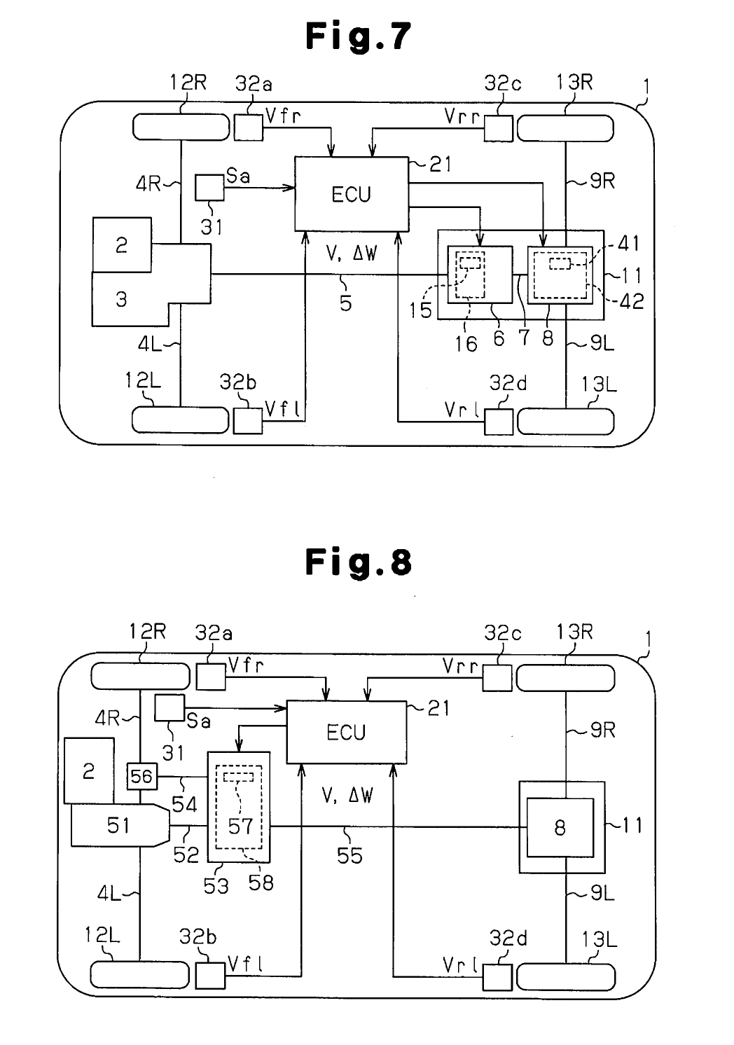

As shown in FIG. 7, a rear differential 8 serving as a differential apparatus is coupled to a right rear axle 9R and a left rear axle 9L, each of which serves a first drive axle, as in the case of the first embodiment.

The rear differential 8 includes an electromagnetic clutch 42, which serves as a limited slip differential. The frictional engaging force of the electromagnetic clutch 42 is changed in accordance with the amount of current supplied to an electromagnetic coil 41. The electromagnetic clutch 42 is configured to change differential limiting force (frictional engaging force), which limits the speed difference between the right rear axle 9R and the left rear axle 9L, in accordance with the amount of current supplied to the electromagnetic coil 41.

Also, the rear differential 8 (the electromagnetic clutch 42) is connected to the ECU 21, which functions as a differential limiting force controller. The ECU 21 supplies drive current to the electromagnetic coil 41 in accordance with the driving state of the vehicle 1 to control the operation of the electromagnetic clutch 42, thereby controlling the differential limiting force. Therefore, in the second embodiment, the rear differential 8, the electromagnetic clutch 42, and the ECU 21 form a differential limiting control apparatus.

When only one of the right rear wheel 13R coupled to the right rear axle 9R and the left rear wheel 13L coupled to the left rear axle 9L slips, the ECU 21 executes a protection control to reduce the differential limiting force of the electromagnetic clutch 42 to a value less than or equal to a predetermined differential limiting force. The predetermined differential limiting force is a value at which it is possible to prevent torsional vibration generated when torsion of a driving power transmitting member (for example, the left rear axle 9L) is released from being transmitted to the other driving power transmitting members. For example, the predetermined differential limiting force is set to zero.

Accordingly, when only one of the right and left rear wheels 13R, 13L slips, the ECU 21 reduces the differential limiting force of the electromagnetic clutch 42 to a value less than or equal to the predetermined differential limiting force. This configuration prevents shock from being transmitted to a portion of the driving power transmission system that is located beyond the electromagnetic clutch 42 as seen from the slipping wheel (the right rear wheel 13R or the left rear wheel 13L).

Specifically, for example, when the left rear wheel 13L slips, the torsion in the left rear axle 9L is released. This generates torsional vibration. The configuration prevents the torsional vibration from being transmitted to the transaxle 3, the right and left front axles 4R, 4L, the propeller shaft 5, the torque coupling 6, the pinion shaft 7, and the right rear axle 9R.

The second embodiment provides the same advantages as the first embodiment.

### Third Embodiment

A third embodiment of the present invention will now be described with reference to the drawings.

For purposes of illustration, like or same reference numerals are given to those components that are like or the same as the corresponding components of the first embodiment and detailed explanations are omitted.

As shown in FIG. 8, a vehicle 1 is a rear drive-based four-wheel drive vehicle. A transmission 51 is attached to the engine 2. The transmission 51 is coupled to a center differential 53, which function s as a differential apparatus, through an input shaft 52. The center differential 53 is coupled to a first propeller shaft 54 serving as a first drive shaft and a second propeller shaft 55 serving as a second drive shaft. The first propeller shaft 54 is coupled to a pair of right and left front axles 4R, 4L with a front differential 56 in between. The second propeller shaft 55 is coupled to a pair of right and left rear axles 9R, 9L with a rear differential 8 in between.

The center differential 53 allows the first propeller shaft 54 and the second propeller shaft 55 to rotate at different speeds, and distributes torque transmitted through the input shaft 52 to the first and second propeller shafts 54, 55 in accordance with the speed difference.

The center differential 53 includes an electromagnetic clutch 58, which serves as a limited slip differential. The frictional engaging force of the electromagnetic clutch 58 is changed in accordance with the amount of current supplied to an electromagnetic coil 57. The electromagnetic clutch 58 is configured to change differential limiting force (frictional engaging force), which limits the speed difference between the first propeller shaft 54 and the second propeller shaft 55, in accordance with the amount of current supplied to the electromagnetic coil 57.

Therefore, the torque of the engine 2 is first transmitted to the center differential 53 from the transmission 51 through the input shaft 52. Then, the torque of the engine 2 is transmitted from the center differential 53 to the right and left front wheels 12R, 12L via the first propeller shaft 54, the front differential 56, and the right and left front axles 4R, 4L. Also, the torque of the engine 2 is transmitted from the center differential 53 to the right and left rear wheels 13R, 13L via the second propeller shaft 55, the rear differential 8, and the right and left rear axles 9R, 9L.

In the third embodiment, the driving power transmitting members, which include the transmission 51, the input shaft 52, the center differential 53, the right and left front axles 4R, 4L, the first and second propeller shafts 54, 55, the front differential 56, the rear differential 8, the right and left rear axles 9R, 9L, form a driving power transmission system.

Also, the center differential 53 (the electromagnetic clutch 58) is connected to the ECU 21, which functions as a differential limiting force controller. The ECU 21 supplies drive current to the electromagnetic coil 57 in accordance with the driving state of the vehicle 1 to control the operation of the electromagnetic clutch 58, thereby controlling the differential limiting force. Therefore, in the third embodiment, the center differential 53, the electromagnetic clutch 58, and the ECU 21 form a differential limiting control apparatus.

When only one of the right and left front wheels 12R, 12L coupled to the first propeller shaft 54 and the right and left rear wheels 13R, 13L coupled to the second propeller shaft 55 slips, that is, when only one of the four wheels slips, the ECU 21 executes a protection control to reduce the differential limiting force of the electromagnetic clutch 58 to a value less than or equal to a predetermined differential limiting force as in the first embodiment.

Accordingly, when only one of the four wheels slips, the ECU 21 reduces the differential limiting force of the electromagnetic clutch 58 to a value less than or equal to the predetermined differential limiting force. This configuration prevents shock from being transmitted to a portion of the driving power transmission system that is located beyond the electromagnetic clutch 58 as seen from the slipping wheel.

Specifically, for example, torsional vibration that is generated when torsion of the left front axle 4L is released by slipping of the left front wheel 12L is prevented from being transmitted to the second propeller shaft 55, the rear differential 8, and the right and left rear axles 9R, 9L.

The third embodiment provides the same advantages as the first embodiment.

The above described embodiments may be modified as follows.

In the first and second embodiments, the torque coupling 6 is located between the propeller shaft 5 and the pinion shaft 7. However, the torque coupling 6 may be located elsewhere in the driving power transmission system. For example, the torque coupling 6 may be located between the rear differential 8 and the right rear wheel 13R and between the rear differential 8 and the left rear wheel 13L.

In the first and second embodiments, the present invention is applied to the vehicle 1 in which the right and left front wheels 12R, 12L function as main drive wheels. Instead, the present invention may be applied to a vehicle 1, in which the right and left rear wheels 13R, 13L function as main drive wheels. Also, in the third embodiment, the present invention may be applied to a vehicle in which the right and left front wheels 12R, 12L function as main drive wheels.

In the second embodiment, the electromagnetic clutch 42 serving as a limited slip differential is provided in the rear differential 8. Instead, an electromagnetic clutch serving as a limited slip differential may be provided in a front differential, and the same control as the second embodiment may be executed.

In the above illustrated embodiments, if the slipping of only one of the wheels has continued in the protection control, the ECU 21 determines that torsional vibration has been damped and the shock applied to the driving power transmission system has been decreased, and switches the control mode to the normal control. However, the ECU 21 does not necessarily need to switch the control mode to the normal control even if slipping continues for a predetermined period. In this case, when the slipping wheel (for example, the left front wheel 12L) exits the low μ road surface 33b and holds the road 33, torque the amount of which is greater than or equal to the torque transmission amount of the torque coupling 6 is reliably prevented from being transmitted to a portion of the driving power transmission system that is located beyond the torque coupling 6 as seen from the left front wheel 12L.

In the illustrated embodiments, when the wheel speed differences between the four wheels are all less than or equal to the second threshold value K2, the ECU 21 determines that slipping of a wheel has subsided, and switches the control mode to the normal control. Instead, the ECU 21 does not necessarily need to switch the control mode to the normal control when slipping of a wheel subsides.

Further, in the illustrated embodiment, when the accelerator pedal depression degree Sa is less than or equal to the predetermined depression degree Sath, the ECU 21 determines that slipping of a wheel has subsided, and switches the control mode from the protection control to the normal control. Instead, the ECU 21 does not necessarily need to switch the control mode to the normal control when the accelerator pedal depression degree Sa is less than or equal to the predetermined depression degree Sath.

In the protection control, the ECU 21 may switch the control mode to the normal control when a condition other than those presented above is met.

In the illustrated embodiments, when the wheel speed of any one of the wheels is greater than or equal to the value calculated by adding the first threshold amount K1 to the average wheel speed of the other three wheels, and all the wheel speed differences between the latter three wheels are less than or equal to the second threshold value K2, the ECU 21 determines that only the first wheel has slipped. However, the present invention is not limited to this. For example, the ECU 21 may determine that only one wheel has slipped on condition only that the wheel speed of one wheel is greater than or equal to the value calculated by adding the first threshold amount K1 to the average wheel speed of the other three wheels. Besides this, the ECU 21 may detect slipping by other methods, for example, by using acceleration of the wheels.

In the illustrated embodiments, the ECU 21 switches the control mode to the protective mode when only one of the wheels 12R, 12L, 13R, 13L slips. However, the ECU 21 may switch the control mode to the protective mode when two or more of the wheels 12R, 12L, 13R, 13L slip.

1. A driving power distribution control apparatus for controlling driving power that is distributed from a driving power source of a vehicle to each of a plurality of wheels, the apparatus comprising:
a torque coupling provided in a driving power transmission system that transmits, as the driving power, torque of the driving power source to each of the wheels, wherein, based on an engaging force of a clutch mechanism that transmits the driving power, the torque coupling is capable of changing the amount of torque transmission, which amount is torque that is transmittable from an input side to an output side;
a torque transmission amount controller that controls the operation of the torque coupling based on the driving state of the vehicle; and
slip detection means that detects slip of wheels,
wherein, when the slip detection means detects that at least one of the wheels has slipped, the torque transmission amount controller reduces the torque transmission amount of the torque coupling.

2. The driving power distribution control apparatus according to claim 1, wherein, when a wheel speed of any one of the wheels is greater than or equal to a value calculated by adding a first threshold amount to an average wheel speed of the other wheels and the speed differences between wheel speeds of the other wheels are all less than or equal to a second threshold value, the slip detection means determines that only said one of the wheels has slipped.

3. A differential limiting control apparatus comprising a differential apparatus, a differential limiting force controller, and slip detection means, wherein the differential apparatus transmits torque of a driving power source of a vehicle to a first drive shaft and a second drive shaft, while permitting the first and second drive shafts to rotate at different speeds, the differential apparatus having a limited slip differential that limits the speed difference between the first drive shaft and the second drive shaft, wherein the differential limiting force controller controls a differential limiting force of the limited slip differential, and wherein the slip detection means detects slip of any of wheels that are coupled to the first drive shaft or the second drive shaft,
wherein, when the detection means detects slip of a wheel coupled to the first drive shaft or the second drive shaft, the differential limiting force controller reduces the differential limiting force of the limited slip differential.

4. A method for controlling a torque coupling provided in a driving power transmission system that transmits, as a driving power, torque of a driving power source to each of a plurality of wheels, wherein, based on an engaging force of a clutch mechanism that transmits the driving power, the torque coupling is capable of changing the amount of torque transmission, which amount is torque that is transmittable from an input side to an output side,
wherein, when it is detected that at least one of the wheels has slipped, the torque transmission amount of the torque coupling is reduced.

5. A method for controlling a differential apparatus that transmits torque of a driving power source of a vehicle to a first drive shaft and a second drive shaft, while permitting the first and second drive shafts to rotate at different speeds, the differential apparatus having a limited slip differential that limits the speed difference between the first drive shaft and the second drive shaft,
wherein, when it is detected that at least one of the wheels has slipped, the differential limiting force of the limited slip differential is reduced.
